(19) United States
(12) Patent Application Publication
(10) Pub. No.: US 2016/0221830 A1
(43) Pub. Date: Aug. 4, 2016

(54) METHOD OF PRODUCING GRAPHENE FILM

(71) Applicant: FUJITSU LIMITED, Kawasaki-shi (JP)

(72) Inventor: Kenjiro HAYASHI, Hadano (JP)

(73) Assignee: FUJITSU LIMITED, Kawasaki (JP)

(21) Appl. No.: 15/094,249

(22) Filed: Apr. 8, 2016

Related U.S. Application Data
(63) Continuation of application No. PCT/JP2014/078318, filed on Oct. 24, 2014.

(30) Foreign Application Priority Data
Oct. 25, 2013 (JP) 2013-222291

(51) Int. Cl. C01B 31/04; B32B 38/10; B32B 37/00

(52) U.S. Cl. CPC C01B 31/0453; B32B 37/025; B32B 38/10; C01B 2204/04

(57) ABSTRACT

A method includes forming a first graphene film on a first substrate, applying a support film to the first graphene film, removing the first substrate to form a structure where the first graphene film is supported by the support film, forming a second graphene film on a second substrate, transferring the first graphene film supported by the support film onto the second graphene film formed on the second substrate to form a multilayer graphene film where the first graphene film and the second graphene film are stacked, removing the second substrate to form a structure where the multilayer graphene film is supported by the support film, transferring the multilayer graphene film onto a third substrate, and removing the support film to form a structure where the multilayer graphene film is formed on the third substrate.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2014/078318, filed on Oct. 24, 2014, which claims the benefit of priority of the prior Japanese Patent Application No. 2013-222291, filed on Oct. 25, 2013, the entire contents of which are incorporated herein by reference.

### FIELD

An aspect of this disclosure relates to a method of producing a graphene film.

### BACKGROUND

Copper has been used as a material for wiring of large-scale integrated (LSI) circuits. However, as the LSI circuits become smaller and the width of wires made of copper decreases, a sharp increase in the electrical resistivity of the wires has become a problem. Also, as the current density increases, failure of circuits due to electromigration (atomic diffusion) has become another problem. For these reasons, a new material usable in place of copper is desired for fine wiring.

Here, graphene has excellent electrical characteristics, excellent mechanical strength, and excellent thermal and chemical stability, and is expected to be a material for next-generation electronic devices. Graphene is a basic component of graphite, and is a two-dimensional layered material that has a hexagonal lattice structure of carbon atoms and has a thickness of only one carbon atom. In a bulk form, graphene has conductivity of the same order as that of copper and a current density tolerance that is about one-hundred times greater than that of copper. It is theoretically predicted that the resistance of a graphene wire with a nanometer width becomes smaller than that of a copper wire with the same width. Therefore, graphene is expected to be a basic material for fine wiring of next-generation LSI circuits (see, for example, Azad Naeemi et al., “Compact Physics-Based Circuit Models for Graphene Nanoribbon Interconnects”, IEEE Trans. Electron Devices, 56 (2009) 1822; and W. Steinhögl et al., “Comprehensive study of the resistivity of copper wires with lateral dimensions of nm and smaller”, J. Appl. Phys. 97 (2005) 023706).

In recent years, it has become possible to produce a high-quality, large-area graphene film with a chemical vapor deposition (CVD) method. For example, it has been reported that a multilayer graphene film including several tens to several hundred of layers and having a quality as high as that of graphite can be formed by using a film of metal such as Fe, Ni, or Co as a catalyst (see, for example, Daiyu Kondo et al., “Low-Temperature Synthesis of Graphene and Fabrication of Top-Gated Field Effect Transistors without Using Transfer Processes”, Appl. Phys. Express 3 (2010) 025102; and Keun Soo Kim et al., “Large-scale pattern growth of graphene films for stretchable transparent electrodes”, Nature 457 (2009) 706).

However, when a metal catalyst is used, the number of layers of graphene varies depending on positions, and it is difficult to secure in-plane uniformity in film thickness (the number of layers). Because the electrical resistivity of graphene depends on the number of layers, a technology to produce a uniform multilayer graphene film by strictly controlling the number of layers is very important to produce a reliable fine wiring in a large-area.

It has been discovered that high-quality, uniform graphene having substantially a single layer can be formed on the surface of a catalyst by using copper as a metal catalyst film during synthesis (see, for example, Xuesong Li, et al., “Large-Area Synthesis of High-Quality and Uniform Graphene Films on Copper Foils”, Science 324 (2009) 1312). It has also been reported that a uniform graphene film with two to four layers can be selectively synthesized (see, for example, Zhengzong Sun et al., “Large-Area Bernal-Stacked Bi-, Tri-, and Tetralayer Graphene”, ACS Nano 6 (2012) 9790). However, because the number of layers of graphene that can be produced with these related-art technologies is small, the produced graphene has a high electrical resistance and does not have sufficient conductivity comparable to that of a copper wire.

Single-layer graphene has very high electron mobility due to its unique electronic state, and its application to next-generation transistors is expected. However, because graphene itself is not a semiconductor and has characteristics like a metal with no band gap, graphene cannot be used for a channel of a transistor without modification. On the other hand, it has been reported that a band gap appears in a two-layer graphene film with uniform in-plane crystal orientation due to interaction between the two layers, and an experiment is underway to produce a transistor using the two-layer graphene film.

To produce an electronic device using a graphene film on a surface of a metal catalyst film, it is necessary to transfer the graphene film onto a desired substrate according to the characteristics of the electronic device. For this purpose, there are known transfer methods that use, for example, a resist or a resin as a support film (see, for example, Alfonso Reina et al., “Transferring and Identification of Single- and Few-Layer Graphene on Arbitrary Substrates”, J. Phys. Chem. C 112 (2008) 17741-17744; Japanese Laid-Open Patent Publication No. 2013-508247; and Japanese Laid-Open Patent Publication No. 2013-043820).

Also, it is known that the structure of a graphene film with two or more layers retains its stability even after intercalation where foreign atoms and molecules are inserted between the layers of the graphene film (see, for example, M. S. Dresselhaus et al., “Intercalation compounds of graphite”, Adv. Phys. 51:1 (2002) 1-186). The electrical characteristics of a graphene film change depending on a material to be intercalated. For example, it is known that when ferric chloride molecules are intercalated between layers of graphite, the electrical conductivity of the graphite increases by about one digit compared with pristine graphite (see, for example, M. S. Dresselhaus et al., “Intercalation compounds of graphite”, Adv. Phys. 51:1 (2002) 1-186).

Also, a graphene film whose crystal orientation is known can be produced by using a crystal metal film as a catalyst. For example, an epitaxial (crystalline) Co film with a (0001) surface can be formed by forming a Co thin film on a sapphire substrate having a C plane and heating the Co thin film at about 1000° C. Because the matching relationship between crystal orientations at the interface between the sapphire substrate and the Co film is known, when the orientation of the sapphire substrate is known, the in-plane orientation of the formed crystalline Co film can also be determined. Further, because a graphene film is epitaxially grown by a CVD method on the crystalline Co film, when the orientation of the sapphire substrate is known, the crystal orientation of the graphene film can be determined (see, for example, Hiroki Ago et al., “Epitaxial Chemical Vapor Deposition Growth of Single-Layer Graphene over Cobalt Film Crystallized on Sapphire”, ACS Nano 4 (2010) 7407-7414; and WO 2011/025045).

### SUMMARY

According to an aspect of this disclosure, there is provided a method that includes forming a first graphene film on a first substrate, applying a support film to the first graphene film, removing the first substrate to form a structure where the first graphene film is supported by the support film, forming a second graphene film on a second substrate, transferring the first graphene film supported by the support film onto the second graphene film formed on the second substrate to form a multilayer graphene film where the first graphene film and the second graphene film are stacked, removing the second substrate to form a structure where the multilayer graphene film is supported by the support film, transferring the multilayer graphene film onto a third substrate, and removing the support film to form a structure where the multilayer graphene film is formed on the third substrate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A through 1C are drawings illustrating a method of producing a graphene film according to a first embodiment;

FIGS. 2A through 2C are drawings illustrating a method of producing a graphene film according to the first embodiment;

FIGS. 3A through 3C are drawings illustrating a method of producing a graphene film according to the first embodiment;

FIGS. 4A through 4C are drawings illustrating a method of producing a graphene film according to the first embodiment;

FIGS. 5A and 5B are drawings illustrating a method of producing a graphene film according to the first embodiment;

FIGS. 6A through 6C are drawings illustrating a method of producing a graphene film according to a second embodiment;

FIGS. 7A through 7C are drawings illustrating a method of producing a graphene film according to the second embodiment; and

FIGS. 8A and 8B are drawings illustrating a method of producing a graphene film according to the second embodiment.

### DESCRIPTION OF EMBODIMENTS

As described above, high-quality, multilayer graphene can be obtained with a CVD method using a film of metal such as Fe, Ni, or Co as a catalyst. With this method, however, it is difficult to achieve the uniformity in the number of layers.

Also, although a uniform graphene film can be synthesized with a CVD method using Cu, the number of layers of the synthesized graphene film is too small and its conductivity is not sufficient compared with a copper wire. Accordingly, the synthesized graphene film is not suitable for wiring of current LSI circuits.

For these reasons, it is being considered to produce a uniform multilayer graphene film by transferring a single-layer graphene film onto the same substrate multiple times.

However, with related-art transfer technologies, a residue of a support film remains on the graphene film as an impurity (see, for example, A. Pirkle et al., “The effect of chemical residues on the physical and electrical properties of chemical vapor deposited graphene transferred to SiO₂”, Appl. Phys. Lett. 99 (2011) 122108). When a graphene film is transferred multiple times, the residues of support films remain between layers of the multilayer graphene film and may degrade the electrical characteristics of the multilayer graphene film.

Also, although the electrical resistance of a multilayer graphene film can be reduced by intercalation, the impurity remaining between layers of the multiplayer graphene film may inhibit intercalation.

An aspect of this disclosure makes it possible to produce a graphene film while preventing degradation of characteristics of the graphene film due to, for example, a residue of a support film.

Embodiments of the present invention are described below with reference to the accompanying drawings.

### First Embodiment

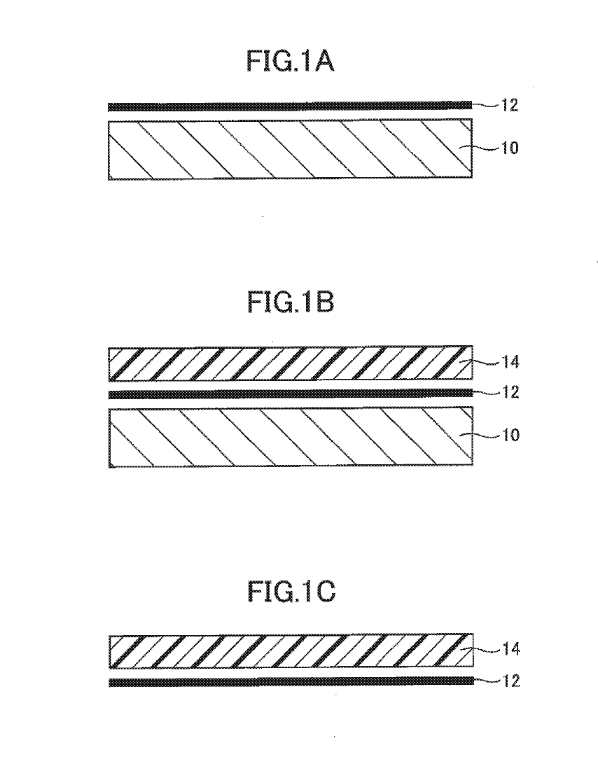

A method of producing a graphene film according to a first embodiment is described below with reference to FIGS. 1A through 5B.

### <First Step>

A uniform graphene film 12 is formed on a catalyst 10 (FIG. 1A).

Exemplary methods for growing the graphene film 12 on the catalyst 10 include thermal chemical vapor deposition (CVD), plasma-enhanced CVD, and molecular beam epitaxy (MBE).

Also, the graphene film 12 may be synthesized on the catalyst 10 by an annealing method where a film (not shown) having a given thickness and including a resist, a resin, and carbon atoms such as amorphous carbon is formed on the catalyst 10, and is annealed in a reducing gas atmosphere.

Also, the graphene film 12 may be prepared by reducing a graphite oxide film on a substrate (not shown).

Further, the graphene film 12 may be prepared by pyrolyzing silicon carbide (SiC) on a substrate (not shown).

When the graphene film 12 is grown on the catalyst 10 by a CVD method, the catalyst 10 may be comprised of any material that can be used to produce a uniform graphene film 12.

Examples of pure metals usable as the catalyst 10 typically include Cu, Ni, Co, Ru, Ag, Pt, and Au. Examples of pure metals usable as the catalyst also include Ti, Fe, Rh, Pd, Re, Os, Ir, Mo, and Ga. When the catalyst 10 is comprised of a pure metal, the impurity concentration of the pure metal is preferably less than or equal to 0.1%. Also, the catalyst 10 may be comprised of an alloy including at least one of these pure metals. Further, the catalyst 10 may be comprised of an oxide or a nitride of one of these pure metals.

The thickness of the catalyst 10 may be, for example, about 1 nm to 1 mm. The graphene film 12 grown on the catalyst 10 may include a single layer or multiple layers.

For example, the catalyst 10 may be implemented in the form of a foil, or a substrate on which a catalyst film is formed by sputtering or vapor deposition.

The surface of the catalyst 10 preferably has a flatness of the order of submicron.

When the catalyst 10 is implemented in the form of a foil, it is preferable to improve the flatness of the foil by, for example, electropolishing or mechanical polishing because the surface of the foil tends to initially have irregularities of the order of microns.

For example, to electropolish the catalyst 10 implemented as a Cu foil, the Cu foil, as an anode, is immersed in a phosphoric acid solution so as to face a cathode, and a voltage of 1.0 V to 3.0 V is applied between the anode and the cathode for about 1 to 60 minutes. The phosphoric acid solution may be diluted by alcohol, pure water, ethylene glycol, or a liquid including at least one of them. Through the electropolishing, the flatness of the catalyst 10 implemented as a Cu foil can be improved to the order of submicron.

In a thermal CVD method where Cu is used as the catalyst 10, for example, the catalyst 10 is heated at about 800 to 1000° C. for about one second to one hour in an atmosphere of a mixed gas of hydrogen and methane or a mixed gas of hydrogen, methane, and an inert gas (noble gas, nitrogen). With this process, a uniform graphene film 12 can be formed on the catalyst 10.

In the thermal CVD method described above, instead of methane, another hydrocarbon gas such as alkane, alkene, alkyne, ketone, alcohol, or a cyclic compound including carbon may be used as a carbon source.

The temperature and the synthesis time of the thermal CVD method are preferably adjusted according to the type of a carbon source and the type, thickness, and form of the catalyst 10.

The graphene film 12 may also be synthesized without using the catalyst 10. For example, the graphene film 12 may be synthesized directly on an insulated substrate by a thermal CVD method, a plasma CVD method, or an MBE method using a hydrocarbon gas, or an MBE method or an annealing method using a solid carbon source. Examples of insulated substrates include an Si substrate with SiO₂, a quartz substrate, an alumina substrate, a sapphire substrate, a mica substrate, and an SiN substrate.

In all of the methods described above, the number of layers of the graphene film 12 to be synthesized is not limited to any specific value.

### <Second Step>

Next, a support film 14 is applied to the graphene film 12 (FIG. 1B).

The support film 14 may be implemented by, for example, a resist or a resin. Examples of resins include an epoxy resin, a phenolic resin, and a silicone resin. The thickness of the support film 14 may be, for example, about 0.1 μm to 100 μm.

For example, a spin coating method may be used to apply the support film 14 to the graphene film 12.

When the catalyst 10 is in the form of a foil, there is a case where the graphene film 12 is formed not only on the front side of the catalyst 10 but also on the back side of the catalyst 10. In this case, the graphene film (not shown) formed on the back side of the catalyst 10 makes it difficult to remove the catalyst 10 in a third step described later. For this reason, the graphene film formed on the back side of the catalyst 10 is removed. For example, the graphene film formed on the back side of the catalyst 10 may be removed by mechanically scraping the graphene film with a tool such as a file, or by oxygen plasma etching.

When the catalyst 10 is in the form of a substrate on which a catalyst film is formed, the substrate is removed after the graphene film 12 is formed on the catalyst film. The substrate may be removed immediately after the graphene film 12 is formed on the catalyst 10, or immediately after the support film 14 is applied to the graphene film 12.

### <Third Step>

Next, the catalyst 10 is removed to form a structure where the graphene film 12 is supported by the support film 14 (FIG. 1C).

As an etchant for removing the catalyst 10, any solution that can dissolve the catalyst 10 may be used. It is preferable to select an appropriate etchant depending on the type of the catalyst 10.

For example, when the catalyst 10 is comprised of Cu, Ni, Co, and Ag, an etchant including nitric acid (HNO₃) is preferable.

When the catalyst 10 is comprised of Fe, Co, and Ni, an etchant including hydrochloric acid (HCl) is preferable.

When the catalyst 10 is comprised of Ti, an etchant including hydrofluoric acid (HF) is preferable.

When the catalyst 10 is comprised of Ti and Mo, a mixed solution of nitric acid and sulfuric acid, or of nitric acid and hydrofluoric acid is preferably used as an etchant.

When the catalyst 10 is any other type of metal catalyst including a noble metal, an etchant including a ferric chloride (FeCl₃) aqueous solution or aqua regia (a solution where HNO₃ and HCl are mixed at a ratio of 3:1) is preferable.

When the graphene film 12 is formed on one surface of the catalyst 10, the catalyst 10 is preferably removed by floating the catalyst 10 on an etchant aqueous solution such that the surface of the catalyst 10 on which the graphene film 12 is formed faces upward and the catalyst 10 is dissolved from the back side on which the graphene film 12 is not formed.

When the catalyst 10 is formed on a substrate and the graphene film 12 is formed on the catalyst 10, the catalyst 10 between the substrate and the graphene film 12 is preferably removed by side etching by immersing the entire structure including the substrate, the catalyst 10, the graphene film 12, and the support film 14 in an etchant. In this case, a support film (not shown) adhering to the side surfaces of the substrate, the catalyst 10, and the graphene film 12 is preferably removed beforehand with a tool such as a file.

Similarly, even when the graphene film 12 is formed by reducing a graphite oxide film on a substrate, formed by pyrolyzing SiC on a substrate, or formed directly on an insulated substrate by an annealing method, the catalyst 10 may be removed either by floating the catalyst 10 on an etchant solution that can dissolve the substrate or by immersing the entire structure in an etchant solution, to form a structure where the graphene film 12 is supported by the support film 14.

### <Fourth Step>

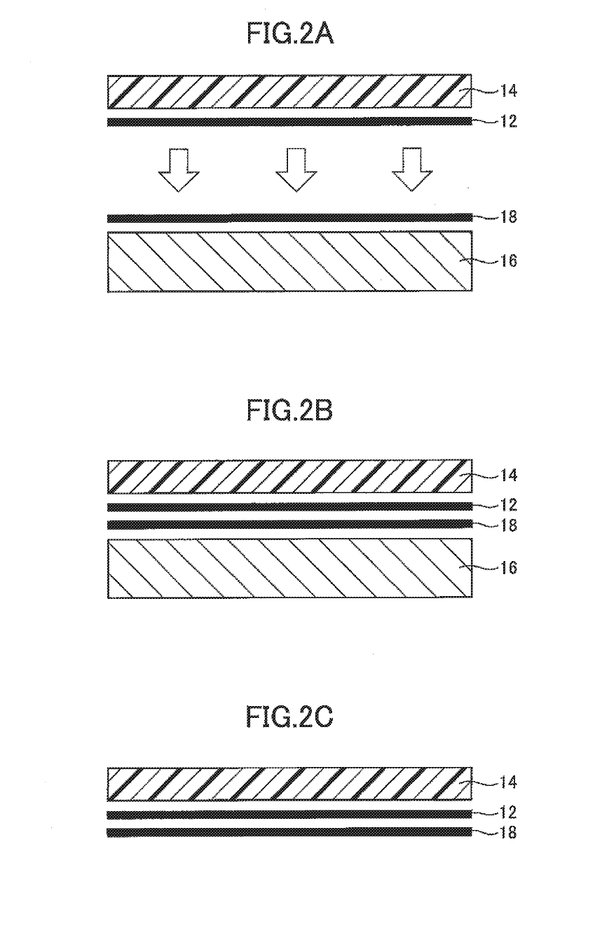

Next, a uniform graphene film 18 is formed on another catalyst 16 with a method similar to that of the first step (FIG. 2A).

Meanwhile, after the catalyst 10 is removed at the third step, the graphene film 12 supported by the support film 14 is floated on, for example, a hydrochloric acid aqueous solution, and then floated on pure water to clean the exposed surface of the graphene film 12.

Next, the graphene film 12 supported by the support film 14 is transferred onto the graphene film formed on the catalyst 16 (FIGS. 2A and 2B). This transfer may be performed, for example, by floating the graphene film 12 supported by the support film 14 on the surface of pure water, and scooping the graphene film 12 by the graphene film 18 formed on the catalyst 16.

After the graphene film 12 is transferred onto the graphene film 18, the entire structure is dried so that water between the graphene film 12 and the graphene film 18 is evaporated, and the graphene film 12 and the graphene film 18 adhere tightly to each other. For example, to improve the adhesion, water between the graphene film 12 and the graphene film 18 may be first expelled by nitrogen blowing, and then the structure may be kept at about 50 t to 180 t using a hot plate. Also, to remove water between the graphene film 12 and the graphene film 18, the entire structure may be kept in a vacuum after the nitrogen blowing.

### <Fifth Step>

Next, the catalyst 16 is removed with a method similar to that of the third step to form a structure where the stacked graphene films 12 and 18 are supported by the support film 14 (FIG. 2C).

### <Sixth Step>

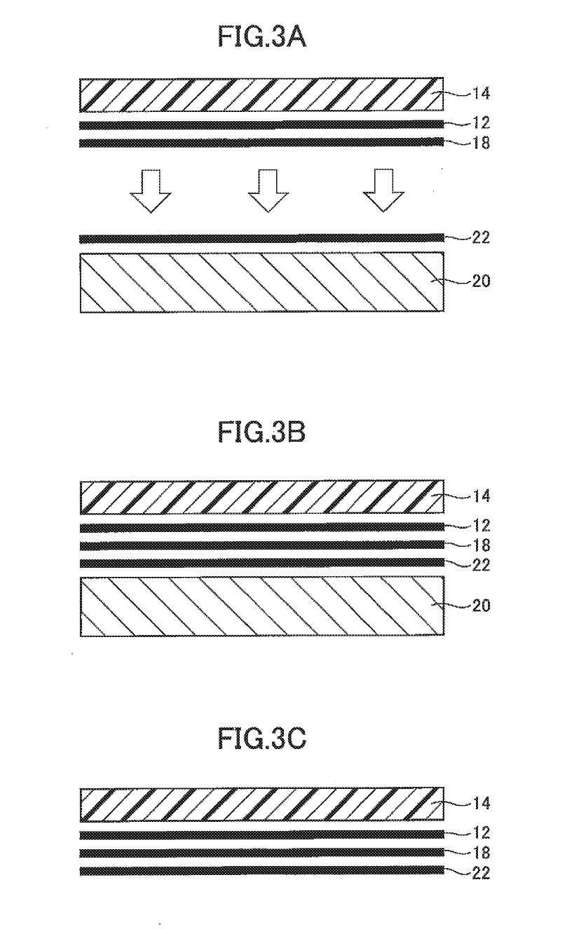

Next, with a method similar to that of the fourth step, the graphene film 12 and the graphene film supported by the support film 14 are transferred onto a graphene film 22 formed on a catalyst 20 (FIGS. 3A and 3B).

First, a uniform graphene film 22 is formed on another catalyst 20 with a method similar to that of the first step (FIG. 3A).

Meanwhile, after the catalyst 16 is removed at the fifth step, the exposed surfaces of the graphene film 12 and the graphene film 18 supported by the support film 14 are cleaned.

Next, the graphene film 12 and the graphene film 18 supported by the support film 14 are transferred onto the graphene film 22 formed on the catalyst 20 (FIGS. 3A and 3B).

After the graphene film 12 and the graphene film 18 are transferred onto the graphene film 22, the entire structure is dried so that water between the graphene film 18 and the graphene film 22 is evaporated, and the graphene film 18 and the graphene film 22 adhere tightly to each other.

### <Seventh Step>

Next, the catalyst 20 is removed with a method similar to that of the third step to form a structure where the stacked graphene films 12, 18, and are supported by the support film 14 (FIG. 3C).

### <Eighth Step>

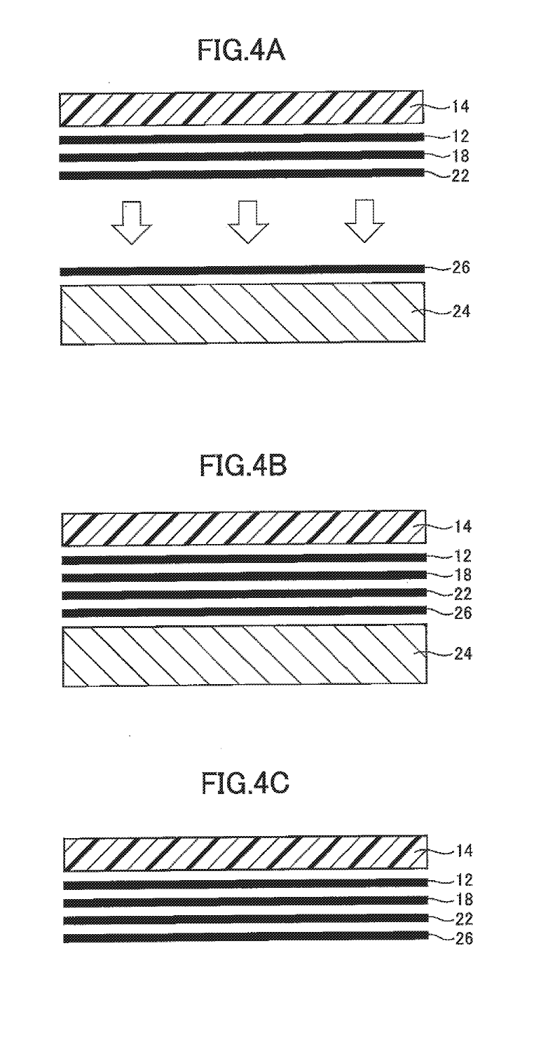

Next, with a method similar to that of the fourth step, the graphene film 12, the graphene film 18, and the graphene film 22 supported by the support film are transferred onto a graphene film 26 formed on a catalyst 24 (FIGS. 4A and 4B).

First, a uniform graphene film 26 is formed on another catalyst 24 with a method similar to that of the first step (FIG. 4A).

Meanwhile, after the catalyst 20 is removed at the seventh step, the exposed surfaces of the graphene film 12, the graphene film 18, and the graphene film 22 supported by the support film 14 are cleaned.

Next, the graphene film 12, the graphene film 18, and the graphene film 22 supported by the support film 14 are transferred onto the graphene film 26 formed on the catalyst 24 (FIGS. 4A and 4B).

After the graphene film 12, the graphene film 18, and the graphene film 22 are transferred onto the graphene film 26, the entire structure is dried so that water between the graphene film 22 and the graphene film 26 is evaporated, and the graphene film 22 and the graphene film 26 adhere tightly to each other.

### <Ninth Step>

Next, the catalyst 24 is removed with a method similar to that of the third step to form a structure where the stacked graphene films 12, 18, 22, and 26 are supported by the support film 14 (FIG. 4C).

### <Tenth Step>

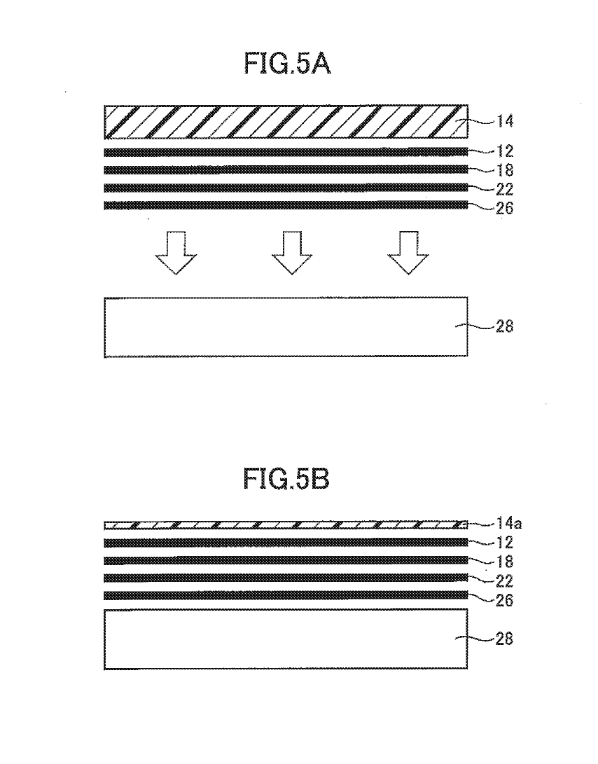

Next, the graphene film 12, the graphene film 18, the graphene film 22, and the graphene film 26 supported by the support film 14 are transferred onto a substrate 28 (FIG. 5A). Examples of the substrate 28 include a silicon substrate with an insulating film, a sapphire substrate, a quartz substrate, and a plastic film.

### <Eleventh Step>

Next, the support film 14 supporting the graphene film 12, the graphene film 18, the graphene film 22, and the graphene film 26 is removed to form a structure where the four layers of the graphene film 12, the graphene film 18, the graphene film 22, and the graphene film 26 are formed on the substrate 28 (FIG. 5B).

For example, the support film 14 may be removed by cleansing the structure formed by the tenth step of FIG. 5A in an organic solvent such as acetone or alcohol. As needed, the structure may also be annealed in a vacuum, an inert gas, hydrogen, or a mixed gas of an inert gas and hydrogen.

Even after the process of removing the support film 14, a residue 14a of the support film 14 sometimes remains as an impurity. However, because the residue 14a remains only on the uppermost graphene film and does not remain between the graphene films 12, 18, 22, and 26 as illustrated by FIG. 5B, the residue 14a does not degrade the characteristics of the stacked graphene films (multilayer graphene film).

When the multilayer graphene film produced as described above is to be used for wiring, the number of layers of the multilayer graphene film is changed depending on, for example, the configuration of a circuit and/or a desired wire width. For example, the number of layers of the multilayer graphene film is preferably determined such that the thickness of the multilayer graphene film becomes substantially the same or twice the wire width.

As a more specific example, when the distance between graphene layers in graphite is about 0.335 nm and the wire width is 5 nm, the thickness of the multilayer graphene film is preferably between 5 nm (about 15 layers) and 10 nm (about 30 layers).

Thus, according to the present embodiment, the characteristics of a multilayer graphene film are not degraded even when a residue of a support film remains on the multilayer graphene film as an impurity.

### Second Embodiment

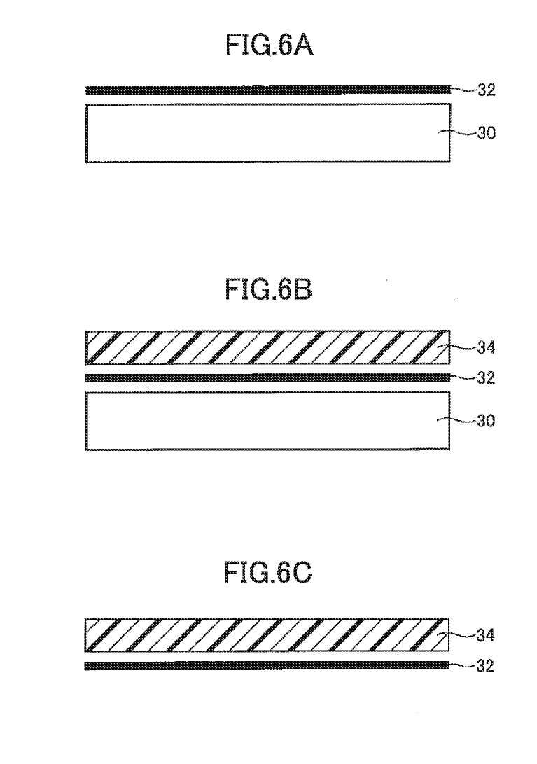

A method of producing a graphene film according to a second embodiment is described below with reference to FIGS. 6A through 8B.

In the second embodiment, a bilayer graphene film, which includes a stack of two graphene films with the same crystal orientation, is formed. The bilayer graphene film has the characteristics of a semiconductor and can be used as a material for a channel of a transistor. Also, the bilayer graphene film may be applied to a light-emitting diode (LED) in the infrared light region and a terahertz infrared photodetector.

### <First Step>

First, a uniform graphene film 32 is formed on a crystalline catalyst 30 (FIG. 6A).

Based on the crystal orientation of the crystalline catalyst 30, a crystalline graphene film 32 having the same crystal orientation as that of the crystalline catalyst 30 is formed on the crystalline catalyst 30. That is, the crystal orientation of the crystalline graphene film 32 is determined by the crystal orientation of the crystalline catalyst 30 on which it is formed.

Exemplary methods for growing the graphene film 32 on the crystalline catalyst 30 include thermal chemical vapor deposition (CVD), plasma-enhanced CVD, and molecular beam epitaxy (MBE).

Also, the graphene film 32 may be synthesized on the crystalline catalyst 30 by an annealing method where a film (not shown) having a given thickness and including a resist, a resin, and carbon atoms such as amorphous carbon is formed on the crystalline catalyst 30, and is annealed in a reducing gas atmosphere.

When the graphene film 32 is grown on the crystalline catalyst 30 by a CVD method, the crystalline catalyst 30 may be any material that can be used to produce a single-layer graphene film 32 having the same crystal orientation as that of the crystalline catalyst 30.

Examples of pure metals usable as the crystalline catalyst 30 typically include Cu, Ni, Co, Ru, Ag, Pt, and Au. Examples of pure metals usable as the crystalline catalyst 30 also include Ti, Fe, Rh, Pd, Re, Os, Ir, Mo, and Ga. When the crystalline catalyst is comprised of a pure metal, the impurity concentration of the pure metal is preferably less than or equal to 0.1%. Also, the crystalline catalyst 30 may be comprised of an alloy including at least one of these pure metals. Further, the crystalline catalyst 30 may be comprised of an oxide or a nitride of one of these pure metals.

The thickness of the crystalline catalyst 30 may be, for example, about 1 nm to 1 mm. The graphene film 32 grown on the crystalline catalyst 30 may include a single layer or multiple layers.

For example, the crystalline catalyst 30 may be implemented in the form of a monocrystalline substrate made of a catalyst material, or a crystalline film made of a catalyst material and formed on a substrate by sputtering or vapor deposition. Examples of substrates for forming a crystalline film of a catalyst material include a sapphire substrate, a mica substrate, and an MgO substrate.

The surface of the crystalline catalyst 30 preferably has a flatness of the order of submicron.

An exemplary thermal CVD method of synthesizing the graphene film 32 is described below. In this exemplary thermal CVD method, a crystalline Cu film formed on a sapphire substrate is used as the crystalline catalyst 30.

First, a Cu film with a thickness of 200 to nm is formed by sputtering on a flat surface of a sapphire substrate having a C plane.

The Cu film is heated at about 1000° C. for about 20 minutes to one hour in a vacuum, in a hydrogen atmosphere, or in an atmosphere of a mixed gas of hydrogen and an inert gas (noble gas, nitrogen). As a result, a high-quality, crystalline Cu catalyst film is formed on the sapphire substrate.

Then, the resulting structure is heated at about 800 to 1000° C. for about one minute to one hour in an atmosphere of a mixed gas of hydrogen and methane or a mixed gas of hydrogen, methane, and an inert gas (noble gas, nitrogen). As a result, a uniform graphene film 32 is formed on the Cu catalyst film on the sapphire substrate.

In the thermal CVD method described above, instead of methane, another hydrocarbon gas such as alkane, alkene, alkyne, ketone, alcohol, or a cyclic compound including carbon may be used as a carbon source.

The temperature and the synthesis time of the thermal CVD method are preferably adjusted according to the type of a carbon source and the type, thickness, and form of the crystalline catalyst 30.

The graphene film 32 may also be formed directly on an insulated substrate (not shown) without using the crystalline catalyst 30. The insulated substrate is preferably a crystalline substrate, such as a quartz substrate, a sapphire substrate, a mica substrate, or an MgO substrate, on which a graphene film with a uniform orientation can be formed.

Further, a single-layer graphene film 32 formed by pyrolyzing silicon carbide (SiC) on a substrate may be used.

In all of the methods described above, the number of layers of the graphene film 32 to be synthesized is not limited to any specific value.

### <Second Step>

Next, a support film 34 is applied to the graphene film 32 (FIG. 6B).

The support film 34 may be implemented by, for example, a resist or a resin. Examples of resins include an epoxy resin, a phenolic resin, and a silicone resin. The thickness of the support film 34 may be, for example, about 0.1 μm to 100 μm.

For example, a spin coating method may be used to apply the support film 34 to the graphene film 32.

When the crystalline catalyst 30 is in the form of a monocrystalline substrate, there is a case where the graphene film 32 is formed not only on the front side of the crystalline catalyst 30 but also on the back side of the crystalline catalyst 30. In this case, the graphene film (not shown) formed on the back side of the crystalline catalyst 30 makes it difficult to remove the crystalline catalyst 30 in a third step described later. For this reason, the graphene film formed on the back side of the crystalline catalyst 30 is removed. For example, the graphene film formed on the back side of the crystalline catalyst 30 may be removed by mechanically scraping the graphene film with a tool such as a file, or by oxygen plasma etching.

When the crystalline catalyst 30 is in the form of a substrate on which a crystalline film of a catalyst material is formed, the substrate is removed after the graphene film 32 is formed on the crystalline film. The substrate may be removed immediately after the graphene film 32 is formed on the crystalline catalyst 30, or immediately after the support film 34 is applied to the graphene film 32.

### <Third Step>

Next, the crystalline catalyst 30 is removed to form a structure where the graphene film 32 is supported by the support film 34 (FIG. 6C).

As an etchant for removing the crystalline catalyst 30, any solution that can dissolve the crystalline catalyst 30 may be used. It is preferable to select an appropriate etchant depending on the type of the crystalline catalyst 30.

For example, when the crystalline catalyst 30 is comprised of Cu, Ni, Co, and Ag, an etchant including nitric acid (HNO₃) is preferable.

When the crystalline catalyst 30 is comprised of Fe, Co, and Ni, an etchant including hydrochloric acid (HCl) is preferable.

When the crystalline catalyst 30 is comprised of Ti, an etchant including hydrofluoric acid (HF) is preferable.

When the crystalline catalyst 30 is comprised of Ti and Mo, a mixed solution of nitric acid and sulfuric acid, or of nitric acid and hydrofluoric acid is preferably used as an etchant.

When the crystalline catalyst 30 is any other type of metal catalyst including a noble metal, an etchant including a ferric chloride (FeCl₃) aqueous solution or aqua regia (a solution where HNO₃ and HCl are mixed at a ratio of 3:1) is preferable.

When the graphene film 32 is formed on one surface of the crystalline catalyst 30, the crystalline catalyst 30 is preferably removed by floating the crystalline catalyst 30 on an etchant aqueous solution such that the surface of the crystalline catalyst 30 on which the graphene film 32 is formed faces upward and the crystalline catalyst 30 is dissolved from another surface on which the graphene film 32 is not formed.

When the crystalline catalyst 30 is formed on a substrate and the graphene film 32 is formed on the crystalline catalyst 30, the crystalline catalyst 30 between the substrate and the graphene film 32 is preferably removed by side etching by immersing the entire structure including the substrate, the crystalline catalyst 30, the graphene film 32, and the support film 34 in an etchant. In this case, a support film (not shown) adhering to the side surfaces of the substrate, the crystalline catalyst 30, and the graphene film 32 is preferably removed beforehand with a tool such as a file.

Similarly, even when the graphene film 32 is formed by pyrolyzing SiC on a substrate, or formed directly on an insulated substrate by an annealing method, the catalyst 32 may be removed either by floating the crystalline catalyst 30 on an etchant solution that can dissolve the substrate or by immersing the entire structure in an etchant solution, to form a structure where the graphene film 32 is supported by the support film 34.

### <Fourth Step>

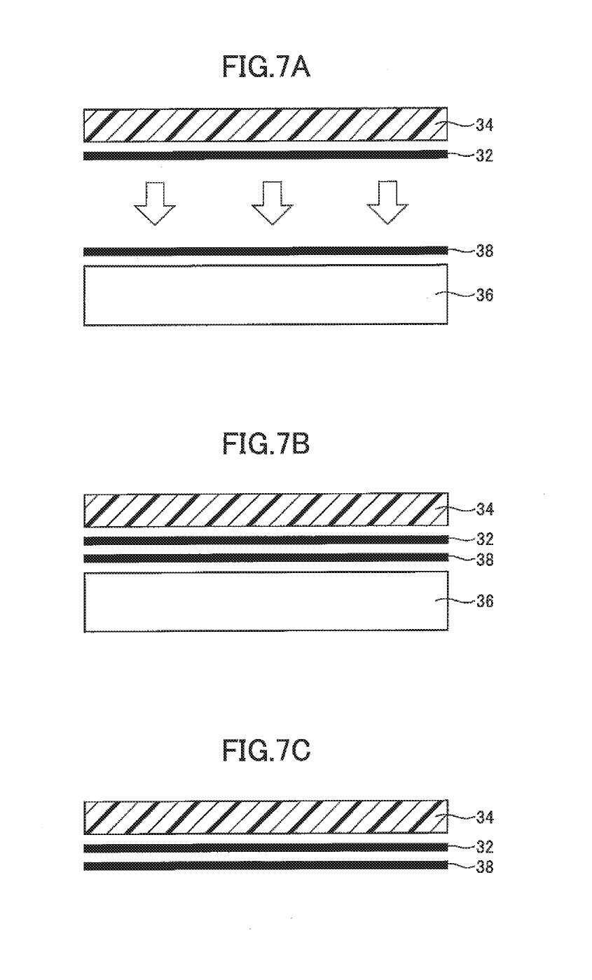

Next, a uniform graphene film 38 is formed on another crystalline catalyst 36 with a method similar to that of the first step (FIG. 7A). The crystal orientation of the crystalline catalyst 36 is the same as the crystal orientation of the crystalline catalyst used in the first step.

Based on the crystal orientation of the crystalline catalyst 36, a crystalline graphene film 38 having the same crystal orientation as that of the crystalline catalyst 36 is formed on the crystalline catalyst 36. Accordingly, the crystal orientation of the crystalline graphene film 32 is the same as the crystal orientation of the crystalline graphene film 38.

Meanwhile, after the crystalline catalyst 30 is removed at the third step, the graphene film 32 supported by the support film 34 is floated on, for example, a hydrochloric acid aqueous solution, and then floated on pure water to clean the exposed surface of the graphene film 32.

Next, the graphene film 32 supported by the support film 34 is transferred onto the graphene film formed on the crystalline catalyst 36 (FIGS. 7A and 7B). This transfer may be performed, for example, by floating the graphene film 32 supported by the support film 34 on the surface of pure water, and scooping the graphene film 32 by the graphene film 38 formed on the crystalline catalyst 36.

After the graphene film 32 is transferred onto the graphene film 38, the entire structure is dried so that water between the graphene film 32 and the graphene film 38 is evaporated, and the graphene film 32 and the graphene film 38 adhere tightly to each other. For example, to improve the adhesion, water between the graphene film 32 and the graphene film 38 may be first expelled by nitrogen blowing, and then the structure may be kept at about 50 t to 180 t using a hot plate. Also, to remove water between the graphene film 32 and the graphene film 38, the entire structure may be kept in a vacuum after the nitrogen blowing.

### <Fifth Step>

Next, the crystalline catalyst 36 is removed with a method similar to that of the third step to form a structure where the stacked graphene films 32 and 38 are supported by the support film 34 (FIG. 7C).

Because the crystal orientation of the crystalline catalyst 30 used in the first step and the crystal orientation of the crystalline catalyst 36 used in the fourth step are the same, the crystal orientations, i.e., the orientations of hexagonal lattices of carbon atoms, of the stacked graphene films 32 and 38 are the same.

### <Sixth Step>

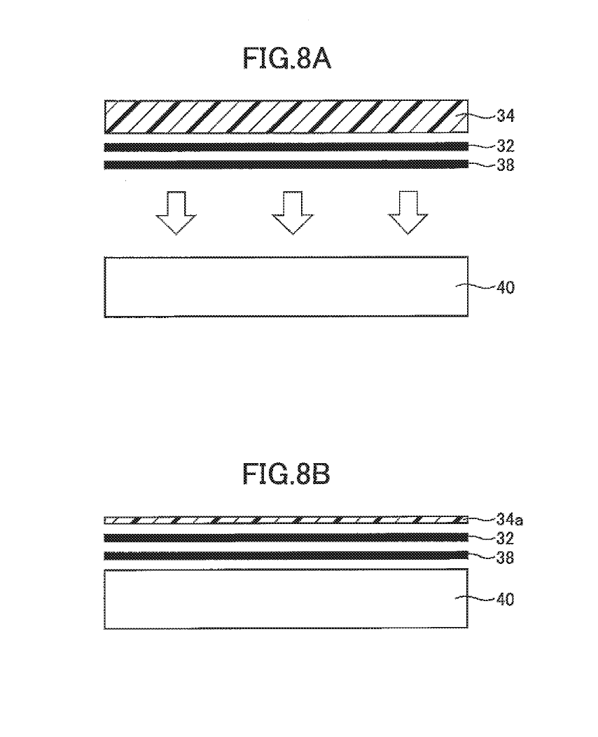

Next, the graphene films 32 and 38 supported by the support film 34 are transferred onto a substrate (FIG. 8A). Examples of the substrate 40 include a silicon substrate with an insulating film, a sapphire substrate, a quartz substrate, and a plastic film.

### <Seventh Step>

Next, the support film 34 supporting the graphene film 32 and the graphene film 38 is removed to form a structure where the two layers of the graphene film 32 and the graphene film 38 are formed on the substrate 40 (FIG. 8B).

For example, the support film 34 may be removed by cleansing the structure formed by the sixth step of FIG. 8A in an organic solvent such as acetone or alcohol. As needed, the structure may also be annealed in a vacuum, an inert gas, hydrogen, or a mixed gas of an inert gas and hydrogen.

Even after the process of removing the support film 34, a residue 34a of the support film 34 sometimes remains as an impurity. However, because the residue 34a remains only on the graphene film 32 and does not remain between the graphene films 32 and 38 as illustrated by FIG. 8B, the residue 34a does not degrade the characteristics of the stacked graphene films (multilayer graphene film).

Thus, according to the present embodiment, the characteristics of a multilayer graphene film are not degraded even when a residue of a support film remains on the multilayer graphene film as an impurity.

### VARIATIONS

Variations can be made to the above embodiments.

For example, although a graphene film is grown on a catalyst or a crystalline catalyst in the above embodiments, a substrate made of a material other than a catalyst or a crystalline catalyst may be used as long as a graphene film can be formed on the substrate.

In the present application, a catalyst, a crystalline catalyst, and a substrate are not necessarily in the form of a substrate having a certain rigidity, and may be in the form of a flexible structure like a foil.

Although four layers of graphene films are stacked in the first embodiment, the number of layers of graphene films may be any number greater than or equal to two.

Although two layers of crystalline graphene films are stacked in the second embodiment, three or more layers of graphene films may be stacked by repeating the fourth and fifth steps.

Although graphene films are stacked by a wet transfer process performed in a liquid in the above embodiments, graphene films may be stacked by a dry transfer process performed in a gas.

In a dry transfer process, synthesized graphene is removed directly from a substrate and transferred onto another substrate. For example, when transferring graphene from a first substrate used to synthesize the graphene to a second substrate, a thermal release tape is affixed to the graphene such that the graphene and the thermal release tape adhere to each other, and then the thermal release tape is removed from the first substrate to obtain the thermal release tape to which only the graphene adheres. Then, the thermal release tape with the graphene is affixed to the second substrate, and is heat-treated to remove only the thermal release tape and transfer the graphene onto the second substrate.

To transfer graphene onto a flexible substrate such as a plastic film, the above method using a thermal release tape may be used. Alternatively, graphene may be transferred onto a flexible substrate by using the flexible substrate itself in place of the thermal release tape. In this case, it is necessary to apply, for example, an adhesive to a surface of the flexible substrate in advance to give adhesiveness to the flexible substrate.

Materials of respective layers and conditions used in the above described methods of forming graphene films are just examples, and may be changed as needed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method, comprising:
forming a first graphene film on a first substrate;
applying a support film to the first graphene film;
removing the first substrate to form a structure where the first graphene film is supported by the support film;
forming a second graphene film on a second substrate;
transferring the first graphene film supported by the support film onto the second graphene film formed on the second substrate to form a multilayer graphene film where the first graphene film and the second graphene film are stacked;
removing the second substrate to form a structure where the multilayer graphene film is supported by the support film;
transferring the multilayer graphene film onto a third substrate; and
removing the support film to form a structure where the multilayer graphene film is formed on the third substrate.

2. The method as claimed in claim 1, further comprising:
before transferring the multilayer graphene film onto the third substrate, repeating a process of forming another graphene film on another substrate, transferring the multilayer graphene film supported by the support film onto the another graphene film formed on the another substrate, and removing the another substrate to form the multilayer graphene film supported by the support film and including three or more stacked graphene films.

3. The method as claimed in claim 1, wherein
the first substrate is a first catalyst for forming the first graphene film; and
the second substrate is a second catalyst for forming the second graphene film.

4. The method as claimed in claim 1, wherein
a crystal orientation of the first substrate is the same as a crystal orientation of the second substrate; and
a crystal orientation of the first graphene film is the same as a crystal orientation of the second graphene film.

5. The method as claimed in claim 1, wherein
each of the first substrate and the second substrate comprises copper;
the first substrate is removed by using ferric chloride; and
the second substrate is removed by using ferric chloride.
